(19) United States
(12) Patent Application Publication
(10) Pub. No.: US 2025/0294116 A1
(43) Pub. Date: Sep. 18, 2025

(54) INFORMATION PROCESSING APPARATUS, INFORMATION PROCESSING SYSTEM, INFORMATION PROCESSING METHOD, AND NON-TRANSITORY RECORDING MEDIUM

(71) Applicants: Shuhei WATANABE, Chiba (JP); Mizuki SHINKAWA, Kanagawa (JP); Ryoichi TERANISHI, Kanagawa (JP); Yuki ABE, Kanagawa (JP)

(72) Inventors: Shuhei WATANABE, Chiba (JP); Mizuki SHINKAWA, Kanagawa (JP); Ryoichi TERANISHI, Kanagawa (JP); Yuki ABE, Kanagawa (JP)

(21) Appl. No.: 19/062,040

(22) Filed: Feb. 25, 2025

(30) Foreign Application Priority Data
Mar. 13, 2024 (JP) 2024-038623
Aug. 23, 2024 (JP) 2024-141960

(51) Int. Cl. H04N 7/15; G06T 11/00; G06V 40/16

(52) U.S. Cl. CPC H04N 7/152; G06T 11/00; G06V 40/174; H04N 7/157

(57) ABSTRACT

An information processing apparatus includes circuitry to: acquire, for each of a plurality of participants who participate in a gathering, unique data indicating unique information of the participant based on an activity of the participant during the gathering; and generate, for each of the plurality of participants, a corresponding image corresponding to the acquired unique data, based on the acquired unique data and a machine learning model trained using training data including the unique data indicating the unique information and an image.

### CROSS-REFERENCE TO RELATED APPLICATIONS

This patent application is based on and claims priority pursuant to 35 U.S.C. § 119 (a) to Japanese Patent Application Nos. 2024-038623, filed on Mar. 13, 2024, and 2024-141960 filed on Aug. 23, 2024, in the Japan Patent Office, the entire disclosure of each is hereby incorporated by reference herein.

### BACKGROUND

### Technical Field

The present disclosure relates to an information processing apparatus, an information processing system, an information processing method, and a non-transitory recording medium.

### Related Art

In a situation where multiple persons participate in a conversation, such as a meeting or other gathering, graphic recording is used to graphically represent the content of the discussion. This enhances common understanding of the content of the meeting.

A communication system, a display apparatus, a display control method, and a display control program according to the related art aim at providing appropriate visual information relating to communication as the communication using voice or a text input goes on. The communication system receives an input of language information. The communication system performs recognition on the input language information. The communication system displays an image corresponding to the input language information on a display, based on a result of the recognition.

### SUMMARY

The present disclosure described herein provides an information processing apparatus including circuitry to: acquire, for each of a plurality of participants who participate in a gathering, unique data indicating unique information of the participant based on an activity of the participant during the gathering; and generate, for each of the plurality of participants, a corresponding image corresponding to the acquired unique data, based on the acquired unique data and a machine learning model trained using training data including the unique data indicating the unique information and an image.

The present disclosure described herein provides an information processing system including circuitry to: acquire, for each of a plurality of participants who participate in a gathering, unique data indicating unique information of the participant based on an activity of the participant during the gathering; and generate, for each of the plurality of participants, a corresponding image corresponding to the acquired unique data, based on the acquired unique data and a machine learning model trained using training data including the unique data indicating the unique information and an image.

The present disclosure described herein provides an information processing method performed by a computer. The information processing method includes: acquiring, for each of a plurality of participants who participate in a gathering, unique data indicating unique information of the participant based on an activity of the participant during the gathering; and generating, for each of the plurality of participants, a corresponding image corresponding to the acquired unique data, based on the acquired unique data and a machine learning model trained using training data including the unique data indicating the unique information and an image.

The present disclosure described herein provides a non-transitory recording medium storing a plurality of program codes which, when executed by one or more processors, causes the one or more processors to perform a method. The method includes: acquiring, for each of a plurality of participants who participate in a gathering, unique data indicating unique information of the participant based on an activity of the participant during the gathering; and generating, for each of the plurality of participants, a corresponding image corresponding to the acquired unique data, based on the acquired unique data and a machine learning model trained using training data including the unique data indicating the unique information and an image.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1A and FIG. 1B are diagrams illustrating configurations of an information processing system according to a first embodiment;

FIG. 2 is a block diagram illustrating a hardware configuration of a terminal apparatus according to the first embodiment;

FIG. 3 is a diagram illustrating a functional configuration of the information processing system according to the first embodiment;

FIG. 4 is a sequence diagram illustrating an example of an operation performed by the information processing system according to the first embodiment;

FIG. 5A to FIG. 5D are diagrams illustrating examples of screens displayed according to the first embodiment;

FIG. 6 is a diagram illustrating a first specific example of a screen;

FIG. 7 is a diagram illustrating a second specific example of the screen;

FIG. 8 is a diagram illustrating a third specific example of the screen;

FIG. 9 is a flowchart of an example of an operation performed by the information processing system according to a second embodiment;

FIG. 10 is a diagram illustrating an example of a screen of a cooperative conference system;

FIG. 11 is a diagram illustrating a first display example of a screen of the cooperative conference system including corresponding images;

FIG. 12 is a diagram illustrating a second display example of the screen of the cooperative conference system including corresponding images;

FIG. 13 is a diagram illustrating a display example of minutes data;

FIG. 14 is a diagram illustrating a functional configuration of the information processing system according to a third embodiment;

FIG. 15 is a block diagram illustrating a hardware configuration of the terminal apparatus according to the fourth embodiment;

FIG. 16 is a diagram illustrating a functional configuration of the information processing system according to a fourth embodiment;

FIG. 17 is a diagram illustrating a functional configuration of the information processing system according to a fifth embodiment; and

FIG. 18 is a diagram illustrating a display example of corresponding images and other images according to the fifth embodiment.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

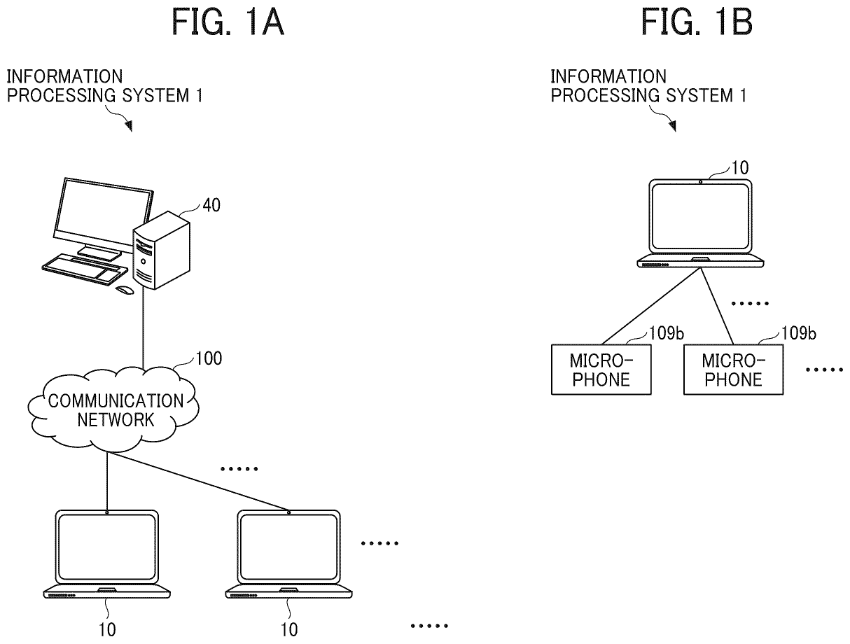

Embodiments of the present disclosure are described below with reference to the drawings. In the present embodiment, although a meeting is described as an example of a gathering, the present embodiment can be applied to gatherings other than a meeting, such as a seminar or a class. FIG. 1A and FIG. 1B are diagrams illustrating configurations of an information processing system 1 according to a first embodiment. FIG. 1A and FIG. 1B depict two examples of the configuration of the information processing system 1.

The configuration illustrated in FIG. 1A corresponds to an online meeting such as a web meeting or a videoconference. In the configuration illustrated in FIG. 1A, terminal apparatuses 10 are respectively provided for participants of the meeting. Each of the terminal apparatuses 10 is connected to a server apparatus 40 through a communication network 100 such as the Internet.

The server apparatus 40 is one or more computers that generate an image based on voice data collected by each of the terminal apparatuses 10.

The configuration illustrated in FIG. 1B corresponds to a face-to-face meeting. In the configuration illustrated in FIG. 1B, one terminal apparatus 10 is provided for multiple participants in a meeting. A microphone 109b is connected to or built in the terminal apparatus 10. The number of microphones 109b may be one or more.

When multiple microphones 109b are provided, a directional microphone may be provided for each participant. With this configuration, a participant who speaks may be identified based on the microphone 109b as a collection source of the voice. According to the configuration illustrated in FIG. 1B, the terminal apparatus 10 generates an image based on voice data collected by the microphone 109b.

In the following description, the configuration illustrated in FIG. 1A may be referred to as “Configuration A,” and the configuration illustrated in FIG. 1B may be referred to as “Configuration B.”

In the present embodiment, the term “meeting” refers to a discussion such as a conversation or a dialogue in which two or more persons participate. The format of the meeting is not limited to a particular one.

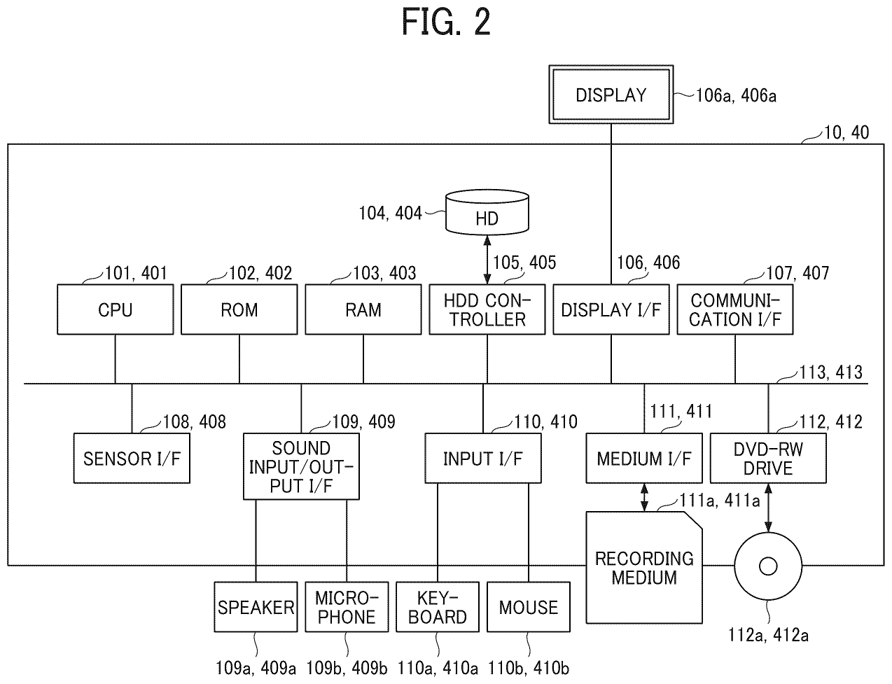

FIG. 2 is a block diagram illustrating a hardware configuration of the terminal apparatus 10 according to the first embodiment. With reference to FIG. 2, the hardware elements of the terminal apparatus 10 are described. Since the hardware elements of the server apparatus 40 are the same as those of the terminal apparatus 10, the descriptions thereof are omitted below. In FIG. 2, the reference numerals of the hardware elements of the terminal apparatus 10 start with “1,” and the reference numerals of the hardware elements of the server apparatus 40 start with “4.”

The terminal apparatus 10 is implemented by a computer. As illustrated in FIG. 2, the terminal apparatus 10 includes a central processing unit (CPU) 101, a read-only memory (ROM) 102, a random-access memory (RAM) 103, a hard disk (HD) 104, a hard disk drive (HDD) controller 105, a display interface (I/F) 106, and a communication I/F 107.

The CPU 101 controls overall operation of the terminal apparatus 10. The ROM 102 stores programs such as an initial program loader (IPL) to boot the CPU 101. The RAM 103 is used as a work area for the CPU 101.

The HD 104 stores various data such as a program. The HDD controller 105 controls reading or writing of various data from or to the HD 104 under control of the CPU 101.

The display I/F 106 is a circuit to control a display 106a to display an image.

The display 106a is, for example, a liquid crystal display or an organic electroluminescence (EL) display that displays various types of information such as a cursor, a menu, a window, characters, and an image. The communication I/F 107 is an interface used for communication with another device (external device).

The communication I/F 107 is, for example, a network interface card (NIC) in compliance with transmission control protocol/internet protocol (TCP/IP).

The terminal apparatus 10 further includes a sensor I/F 108, a sound input/output I/F 109, an input I/F 110, a medium I/F 111, and a digital versatile disk rewritable (DVD-RW) drive 112.

The sensor I/F 108 is an interface that receives data detected by various sensors. The sound input/output I/F 109 is a circuit that processes the input of sound signals from the microphone 109b and the output of sound signals to a speaker 109a under control of the CPU 101. The input I/F 110 is an interface for connecting an input device to the terminal apparatus 10.

A keyboard 110a is a type of input unit and includes multiple keys for inputting characters, numerals, or various instructions. A mouse 110b is a type of input device for selecting or executing various types of instructions, selecting a subject to be processed, moving a cursor, or perform an operation on a display screen.

The medium I/F 111 controls reading and writing (storing) data from or to a recording medium 111a such as a flash memory. The DVD-RW drive 112 controls reading or writing of various data from or to a DVD-RW 112a, which is an example of a removable recording medium. The removable recording medium is not limited to a DVD-RW and may be digital versatile disc-recordable (DVD-R) or the like. Further, the DVD-RW drive 112 may be a Blu-ray® drive to control the reading or writing of various data from or to a Blu-ray® disc.

The terminal apparatus 10 further includes a bus line 113. Examples of the bus line 113 include an address bus and a data bus. The bus line 113 electrically connects the elements, such as the CPU 101, with one another.

The above-mentioned program may be stored in a recording medium, such as a hard disk (HD) and a compact disc read-only memory (CD-ROM), to be distributed domestically or internationally as a program product. The terminal apparatus 10 implements an information processing method according to the present disclosure by, for example, executing a program according to the present disclosure.

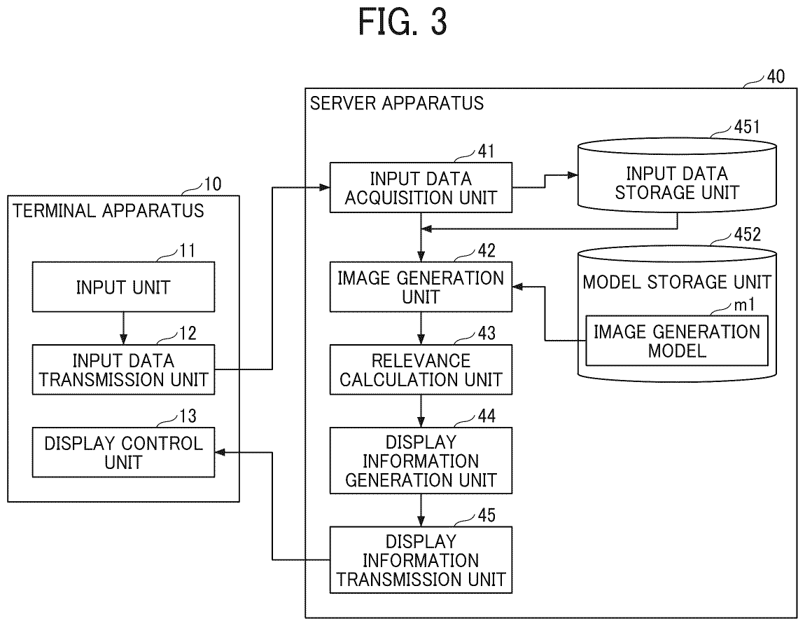

FIG. 3 is a diagram illustrating a functional configuration of the information processing system 1 according to the first embodiment.

As illustrated in FIG. 3, the terminal apparatus 10 includes an input unit 11, an input data transmission unit 12, and a display control unit 13. Each of these functional units is implemented by processes executed by the CPU 101 according to one or more programs installed on the terminal apparatus 10.

The input unit 11 receives an input from a user (a participant of the meeting) of the terminal apparatus 10. The input unit 11 receives information indicating, for example, an agenda (topic) of the meeting and the number of participants, and inputs voice data of speech of the participants in the meeting collected by the microphone 109b during the meeting. In the following description, such information may be referred to as “meeting information.” Furthermore, the input unit 11 may receive, for example, an input of an image relating to the agenda of the meeting from the participant. In the following description, such an image may be referred to as an “input image.”

The input data transmission unit 12 transmits the meeting information or the data received by the input unit 11 to the server apparatus 40.

The display control unit 13 controls display of a screen based on display information transmitted from the server apparatus 40.

The server apparatus 40 includes an input data acquisition unit 41, an image generation unit 42, a relevance calculation unit 43, a display information generation unit 44, and a display information transmission unit 45. Each of these functional units is implemented by processes executed by the CPU 401 according to one or more programs installed on the server apparatus 40. Further, the server apparatus 40 uses an input data storage unit 451 and a model storage unit 452. Each of these storage units is implemented by, for example, the HD 404 or a storage device connectable to the server apparatus 40 through a network.

The input data acquisition unit 41 acquires (receives) the meeting information or data transmitted from the input data transmission unit 12, and records the acquired meeting information or data in the input data storage unit 451. When the server apparatus 40 includes the input data acquisition unit 41 as illustrated in FIG. 3, the input data acquisition unit 41 has a reception function. However, in the case of Configuration B, that is, when the terminal apparatus 10 includes the input data acquisition unit 41, the input data acquisition unit 41 has an input interface function.

The image generation unit 42 generates text data (i.e., text data indicating the content of speech of each participant in the meeting) from the voice data acquired by the input data acquisition unit 41. The image generation unit 42 generates an image corresponding to the text data for each participant based on the text data and an image generation model m1 stored in the model storage unit 452. In the following description, such an image corresponding to the text data may be referred to as a “corresponding image.” Specifically, the image generation unit 42 inputs, for each participant, the text data relating to the participant to the image generation model m1, and acquires an image generated by the image generation model m1 based on the text data as the corresponding image.

The text indicating the content of speech of the participant of the meeting is an example of unique information based on the activity of each participant in the meeting (gathering) during the meeting (gathering.) The text data indicating the content of speech of the participant in the meeting is an example of unique data indicating the unique information of each participant in the meeting.

The unique information of each participant in the meeting may include, in addition to or instead of the text indicating the content of speech of the participant, at least one of characters and operations input by the meeting participant, captured image information of each meeting participant captured by an image capturing device, and biometric information of each meeting participant detected by a biometric information detector.

The image generation model m1 is a machine learning model (generative artificial intelligence (AI)) that generates an image from text data, as an example of a machine learning model (generative AI) that generates an image from the unique data indicating the unique information of each meeting participant. The image generation model m1 is trained using, for example, training data including text data and images. The training data includes, for example, training text data as an input and an image as a correct answer for output. For example, training may be performed so that an image generated by the image generation model m1 to which the text data included in the training data is input becomes closer to an image as a correct answer included in the training data. A commercially available model such as Stable Diffusion® or DALL⋅E® or an independently developed model may be used as the image generation model m1.

The image generation unit 42 generates an integrated corresponding image corresponding to a set of multiple pieces of text data based on the text data of each of the participants and the image generation model m1. Specifically, the image generation unit 42 inputs the set of multiple pieces of text data to the image generation model m1, and acquires an image generated by the image generation model m1 based on the set as the integrated corresponding image. In other words, while the corresponding image is generated for each participant, one integrated corresponding image is generated for all participants.

When an input image, which is an image that is input in relation to a meeting, is input, the image generation unit 42 may generate a corresponding image for each participant based on the text data of each participant, the input image, and the image generation model m1, and may generate an integrated corresponding image corresponding to a set of multiple pieces of text data of participants and the input image. Specifically, the image generation model m1 inputs, for each participant, the text data relating to the participant and the input image to the image generation model m1, and acquires an image generated by the image generation model m1 based on the text data and the input image as the corresponding image. Further, the image generation model m1 inputs the set of multiple pieces of text data to the image generation model m1, and acquires an image generated by the image generation model m1 based on the set as the integrated corresponding image. In this case, the corresponding image or the integrated corresponding image may be, for example, an image obtained by adding changes to the input image in accordance with the content of speech of the participant.

The relevance calculation unit 43 calculates, for each of the corresponding images generated by the image generation unit 42, the relevance degree of each corresponding image with respect to another image. The relevance degree is an index indicating the degree of relevance. The “another image” for a certain corresponding image is, for example, another corresponding image. In this case, the relevance between the corresponding images is calculated. The “another image” may be the integrated corresponding image. In this case, the relevance degree between each corresponding image and the integrated corresponding image is calculated. The “another image” may be an input image or an image generated preliminarily based on particular text data.

The display information generation unit 44 generates display information for displaying each corresponding image. The display information generation unit 44 generates, for example, display information of a screen including the corresponding image. In the generation of the display information, when the display information generation unit 44 recognizes the association between each participant and the corresponding image, the display information generation unit 44 may generate the display information based on which participant identification information that identifies a participant is displayed in association with the corresponding image. The display information generation unit 44 may generate the display information based on which the relevance degree is displayed in association with the participant identification information and the corresponding image.

The display information transmission unit 45 transmits the display information generated by the display information generation unit 44 to the terminal apparatus 10.

When the information processing system 1 has the Configuration B, the terminal apparatus 10 includes the functional units of the server apparatus 40 illustrated in FIG. 3.

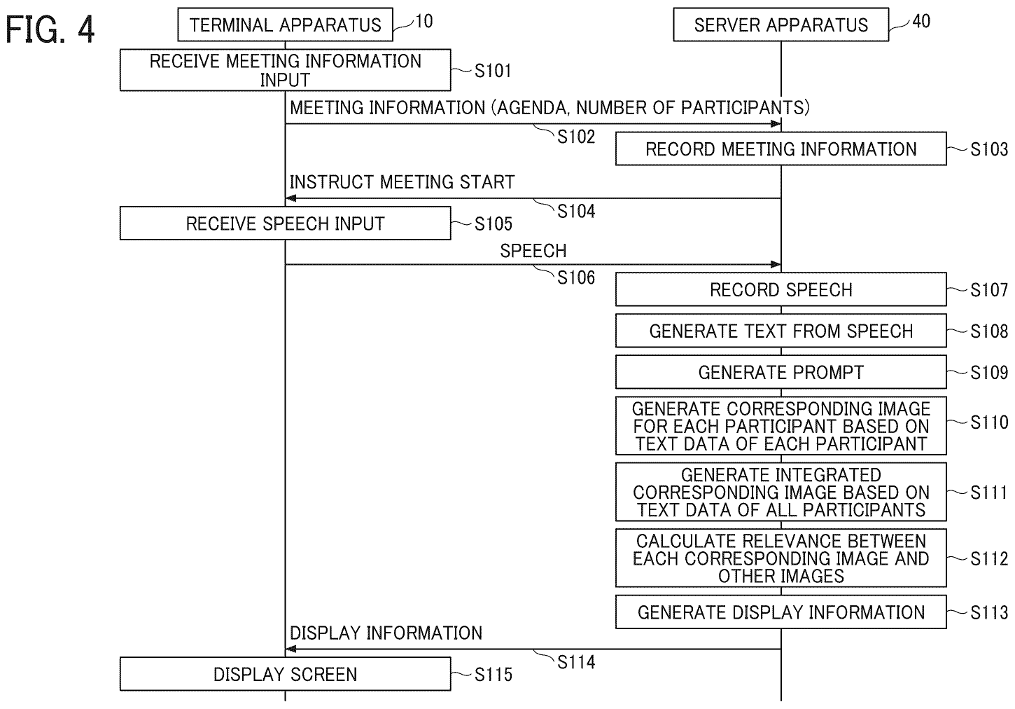

An operation performed by the information processing system 1 is described below. FIG. 4 is a sequence diagram illustrating an example of an operation performed by the information processing system 1 according to the first embodiment. FIG. 4 illustrates an example of the operation performed in a case where the information processing system 1 has the Configuration A. However, in a case where the information processing system 1 has the Configuration B, the terminal apparatus 10 performs the processes performed by the server apparatus 40.

In step S101, the terminal apparatus 10 receives an input of meeting information from one of participants in a meeting via a displayed screen. The one of the participants may be a host of the meeting. The meeting information includes, for example, an agenda and the number of participants.

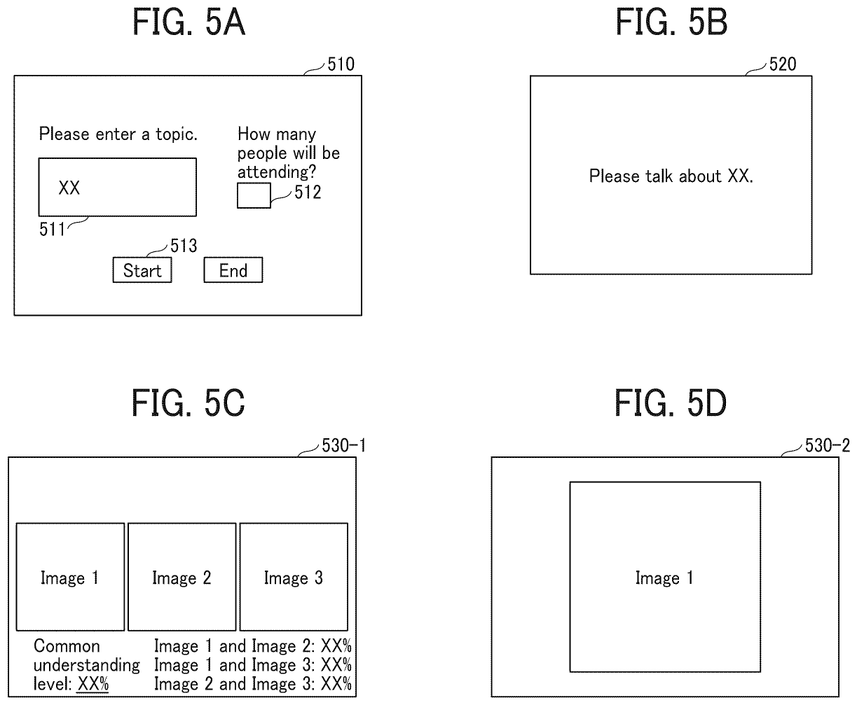

FIG. 5A to FIG. 5D are diagrams illustrating examples of screens displayed according to the first embodiment. In step S101, a screen 510 is displayed on the terminal apparatus 10. The screen 510 may be displayed based on the display information received by the terminal apparatus 10 from the server apparatus 40 before the process of step S101. The screen 510 includes an input area 511, an input area 512, and a start button 513. The input area 511 is an area for receiving an input of an agenda. The input area 512 is an area for receiving an input of the number of participants. The start button 513 is a button for receiving a request to start a meeting.

When the agenda is input to the input area 511, the number of participants is input to the input area 512, and the start button 513 is pressed, in step S102, the input data transmission unit 12 transmits meeting information including the input agenda and number of participants to the server apparatus 40. An input image as described above may be input via the screen 510. For example, a file for storing the input image may be selected via the screen 510, and the input image stored in the file may be transmitted to the server apparatus 40 together with the meeting information.

In step S103, in response to receiving the meeting information, the input data acquisition unit 41 the server apparatus 40 records the meeting information in the input data storage unit 451.

In step S104, the display information transmission unit 45 transmits, for example, display information for displaying an instruction to start a meeting to each of the terminal apparatuses 10. The display control unit 13 of each of the terminal apparatuses 10 displays a screen 520 as illustrated in FIG. 5B based on the display information. The screen 520 includes a message instructing to start a discussion on the agenda. Each participant starts a meeting after looking at the message and speaks his/her understanding or thoughts on the agenda. In the following description, such a meeting may be referred to as a “target meeting.” When one microphone 109b is provided for multiple persons in the target meeting, a known technique may be applied that separates the voices of speeches of the participants who speak. However, the meeting may be progressed such that the participants speak one by one in view of the case of separating the voices of the speeches of the participants. When the microphone 109b is provided for each participant in the target meeting (including an online meeting), multiple persons may be allowed to speak at a time.

The meeting may be started without executing the processes of steps S101 to S104.

In step S105, the input unit 11 of the terminal apparatus 10 receives an input of voice data from the microphone 109b during the target meeting. In step S106, the input data transmission unit 12 transmits the voice data to the server apparatus 40. In step S107, the input data acquisition unit 41 of the server apparatus 40 records the received voice data in the input data storage unit 451. The processes of steps S105 to S107 are repeatedly performed until the target meeting ends. Accordingly, the voice data until the target meeting ends is recorded in the input data storage unit 451. When one microphone 109b is provided for multiple persons, one voice data is recorded for the participants.

On the other hand, when the microphone 109b is provided for each of the participants (including the case of an online meeting), multiple pieces of voice data are recorded respectively for the participants. In this case, the input data acquisition unit 41 may record the multiple pieces of voice data input from the terminal apparatuses 10 or the microphones 109b of the participants in the input data storage unit 451 respectively in association with multiple pieces of identification information of the participants. In the following description, the identification information of the participant may be referred to as “participant identification information.”

The association between the terminal apparatuses 10 or the microphones 109b and the pieces of the participant identification information may be preset.

The time period of the target meeting may be preset in the server apparatus 40, or may be a variable time period until the microphone 109b or the terminal apparatus 10 is powered off.

In step S108, in response to the end of the meeting, the image generation unit 42 performs, for example, transcription and text formatting on the voice data using natural language processing to generate text data. In this step, when the voice data is separated for each participant, the image generation unit 42 generates text data for each participant by generating text data for each voice data. When the voice data is not separated for each participant, the image generation unit 42 also performs speaker separation on the voice data and generates text data for each participant. In this case, the speaker separation may be performed using the number of participants included in the meeting information. Examples of the text formatting include insertion of punctuation marks, and deletion of unnecessary character data and spaces.

In step S109, the image generation unit 42 generates a prompt to be input to the image generation model m1 based on the agenda and the pieces of text data of the participant. In this step, the image generation unit 42 generates a prompt for each of the pieces of text data and a prompt based on a set of all pieces of text data. In the following description, the prompt generated for each of the pieces of text data may be referred to as a “corresponding prompt.” In the following description, the prompt generated based on the set of all pieces of text data may be referred to as an “integrated corresponding prompt.” The corresponding prompt based on certain text data is text data for causing the image generation model m1 to generate a corresponding image based on the agenda and the certain text data.

The integrated corresponding prompt is text data for causing the image generation model m1 to generate an integrated corresponding image based on the agenda and the speeches of all the participants. For both the corresponding prompt and the integrated corresponding prompt, the image generation unit 42 may perform, for example, morphological analysis and important word extraction on the text data as the generation source. Thus, the image generation unit 42 may generate a prompt using a word whose importance is relatively high and the voice data. In the following description, such a word whose importance is relatively high may be referred to as an “important word.” When the image generation model m1 to be used supports a prompt in only a particular language (e.g., English), the image generation unit 42 may perform language conversion (translation) on each prompt and convert the prompt into the language that the image generation model m1 supports. The image generation unit 42 may weight important words in the prompt based on the importances of the important words obtained in the important word extraction. This increases the influence of the important words on the generated image data.

For example, a prompt in which the agenda and the important words are combined is generated as follows.
“<agenda> inspired by (‘work’: 2.692), (‘companion’: 1.923), ‘new’: 1.538), (‘future’: 1.538), (‘ai’: 1.154), (‘robot’: 1.154)”

The <agenda> is a character string indicating the agenda recorded as the meeting information. The words “work,” “companion,” “new,” “future.” “ai,” and “robot” are important words. The number paired with the important word indicates the importance of that word. The format of the above prompt conforms to the grammar of text that the image generation model m1 excepts to input as a prompt. In other words, it is known to the image generation model m1 that the word and its importance are enclosed in parentheses. The format differs depending on an image generation model to be used.

The important word extraction can be performed by using various known technologies such as Term Frequency-Inverse Document Frequency (TF-IDF), TextRank, Rapid Automatic Keyword Extraction (RAKE), and analysis using Transformer.

In step S110, the image generation unit 42 inputs the corresponding prompt to the image generation model m1 for each corresponding prompt, and acquires an image (corresponding image) generated by the image generation model m1 based on the corresponding prompt. Thus, a corresponding image is generated for each corresponding prompt (each participant).

In step S111, the image generation unit 42 inputs the integrated corresponding prompt to the image generation model m1, and acquires an image (integrated corresponding image) generated by the image generation model m1 based on the integrated corresponding prompt.

The processes of S109 and S110 of generating the corresponding image for each participant and the processes of S109 and S111 of generating the integrated corresponding image may be performed in parallel for each image.

Only either the corresponding image or the integrated corresponding image may be generated.

In this case, a setting may be configured according to which either the corresponding image or the integrated corresponding image is generated depending on a user. In a case where the corresponding image is generated for each participant, the seed value of the image generation model m1 is fixed so that when exactly the same prompt is input, exactly the same image data is generated.

In step S112, when the corresponding images are generated, the relevance calculation unit 43 calculates the relevance degree of each corresponding image with respect to another image. As described above, the “another” image is another corresponding image, an integrated corresponding image, an input image, or an image generated preliminarily based on particular text data. For example, when there are three corresponding images, i.e., Images 1 to 3, and the relevance degrees between the corresponding images are calculated, three relevance degrees are calculated, i.e., the relevance degree between the Image 1 and the Image 2, the relevance degree between the Image 1 and the Image 3, and the relevance degree between the Image 2 and the Image 3.

For example, a correlation coefficient may be used as the relevance degree. There are various methods for calculating the correlation coefficient, such as mean squared error (MSE), structural similarity index (SSIM), comparison of histograms, comparison of feature vectors using a neural network, and comparison of objects detected in an image. Any of these methods may be used. A value obtained by linearly combining calculation results by two or more may be adopted.

The value of the relevance degree may be normalized to a range of 0 to 100 in consideration of case of understanding for users. In this case, the larger the value, the higher the correlation (the stronger the relation).

The relevance calculation unit 43 calculates an average of the relevance degrees as the common understanding level. The common understanding level is an index indicating the degree of common understanding among the participants regarding the agenda.

When no corresponding image is generated, that is, when only one integrated corresponding image is generated, the process of step S112 may be omitted.

In step S113, the display information generation unit 44 generates display information (e.g., a screen) for displaying the generated image or images (i.e., the corresponding images or the integrated corresponding image, or the corresponding images and the integrated corresponding image). In this step, when the relevance degree is generated for each corresponding image, the display information generation unit 44 generates display information for displaying the relevance degree in association with each corresponding image and displaying the common understanding level. When the association between each corresponding image and each participant (participant identification information) is clear, the display information generation unit 44 may generate display information for displaying each corresponding image in further association with the participant identification information.

In step S114, the display information transmission unit 45 transmits the generated display information to each of the terminal apparatuses 10. In step S115, in response to the transmitted display information, the display control unit 13 of each of the terminal apparatuses 10 displays a screen 530-1 as illustrated in FIG. 5C or a screen 530-2 as illustrated in FIG. 5D based on the display information. In the following description, the screen 530-1 and the screen 530-2 may be collectively referred to as a “screen 530” unless they need to be distinguished from each other. The screen 530 may be displayed on the display 106a or may be displayed on a projector connected to the terminal apparatus 10.

The screen 530-1 is an example of a screen displayed when three persons participates in a target meeting and corresponding images are generated respectively for the three participants. The screen 530-1 includes, in addition to the corresponding images, the degrees of relevance between the corresponding images (that is, the relevance degree of each of the three pairs of corresponding images) and the common understanding level as display elements. When the association between each corresponding image and the participant can be grasped, the participant identification information may be displayed in association with each corresponding image.

The screen 530-2 is an example of a screen displayed when one integrated corresponding image is generated for all the participants.

When both the corresponding images and the integrated corresponding image are generated, a screen including the display content of the screen 530-1 and the display content of the screen 530-2 may be displayed.

A specific example of the screen 530 that displays the corresponding images or the integrated corresponding image generated when three persons have a meeting on an agenda “about future office” is described below with reference drawings.

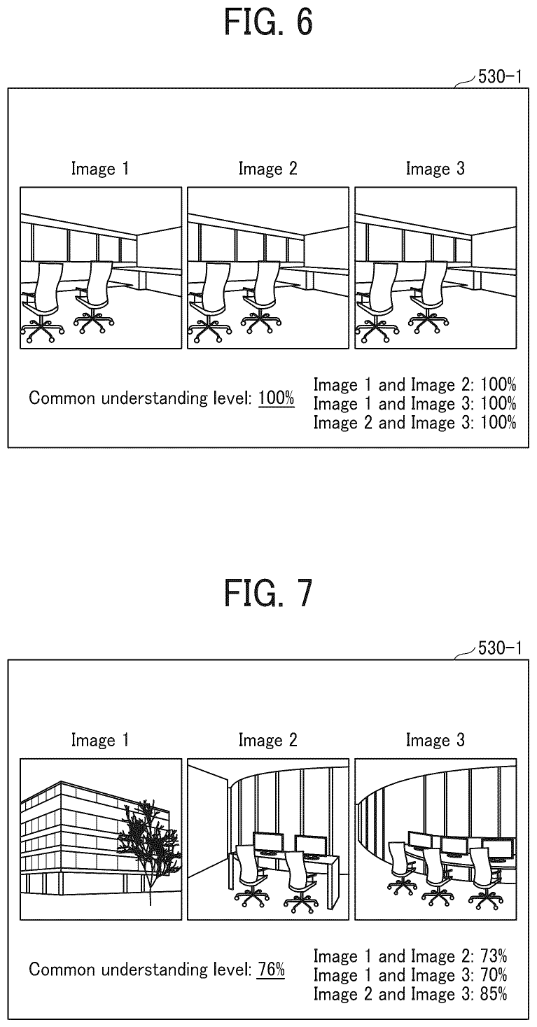

FIG. 6 is a diagram illustrating a first specific example of the screen 530. The screen 530-1 illustrated in FIG. 6 is a screen having the same configuration as the screen 530-1 illustrated in FIG. 5C. FIG. 6 illustrates a display example of the screen 530-1 displayed when three persons have made exactly the same speech. In this case, the contents of the three corresponding images are the same, and the relevance degrees between the corresponding images are all 100%. The common understanding level, which is the average of the relevance degrees, is 100%.

FIG. 7 is a diagram illustrating a second specific example of the screen 530. The screen 530-1 illustrated in FIG. 7 is a screen having the same configuration as the screen 530-1 illustrated in FIG. 5C, as FIG. 6. However, FIG. 7 illustrates a display example of the screen 530-1 displayed when there is a difference in the contents of the speeches of the three persons. In this case, the contents of the three corresponding images differ depending on the speeches of the participants. For this reason, the relevance degree between the corresponding images is not 100%, and the common understanding level is 76%. In this example, a normalized linear sum of the correlation coefficient of the feature vector and the correlation coefficient obtained when a grayscale image is converted into one-dimensional image is used as the common understanding level.

From the contents of the corresponding images and the relevance degree (85%) in FIG. 7, it is understood that the Image 2 (center) and the Image 3 (right) are corresponding images based on the speeches of similar contents. The Image 1 (left) and the Images 2 and 3 appear to be largely different at a glance, they have a common point in the luminance pattern when converted into grayscale. Accordingly, it is understood that there are two different views on the agenda “about future office,” depending on a bird's-eye view (i.e., the appearance of the office) or a subjective view (i.e., the inside of the office), which helps the subsequent discussion.

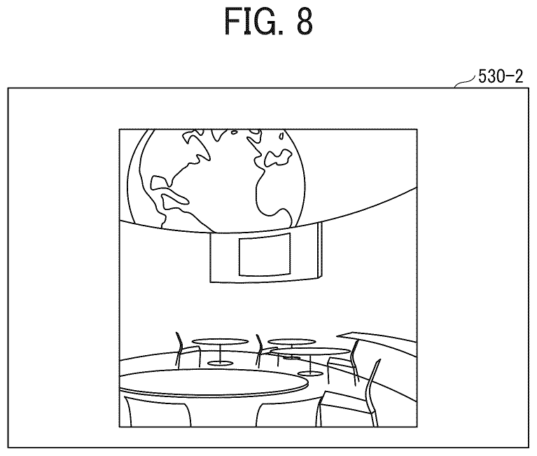

FIG. 8 is a diagram illustrating a third specific example of the screen 530. The screen 530-2 illustrated in FIG. 8 is a screen having the same configuration as the screen 530-2 illustrated in FIG. 5D. In other words, one image included in the screen 530-2 of FIG. 8 is an integrated corresponding image based on the contents of speeches by three persons. Since the one image is generated by mixing the speeches by the three persons, they can stimulate and deepen their discussion based on the visualized information, for example, by saying “This part is different from how I imagined it!” or “I can relate to this part!”

The participants who have viewed the screens 530 and as illustrated in FIG. 6 to FIG. 8 can quantitatively recognize the common understanding level as a numerical value (in the case of FIG. 6 or FIG. 7), and can share the directionality of understanding based on the respective viewpoints in a visible form, i.e., in the form of an image.

In a modified example of the present embodiment, the corresponding image may be displayed without displaying the common understanding level as a numerical value. In this case, by visually comparing the corresponding image based on the content of one's own speech with the corresponding image based on another participant's speech or the integrated corresponding image, one can visually recognize the difference between the impression of the own speech and the impression of the speech of the other participant or the impression of the entire speech.

As described above, according to the first embodiment, an image (e.g., the corresponding image or the corresponding integrated image) is generated using text data indicating the contents of speeches by participants in a meeting and the image generation model m1, and the generated image is displayed. In other words, an image is dynamically generated based on the content of speech. Accordingly, visualization is performed according to unique information of each participant in a meeting. For example, a qualitative event included in speech in a gathering such as a meeting is visualized. The term “qualitative event” refers to a qualitative, invisible, and ambiguous event. Examples of the quotative event include a person's thought and psychology included in the speech.

A second embodiment is described below. In the second embodiment, elements, members, components, or operations that are different from those of the first embodiment are described. In other words, elements, members, components, or operations of which description are omitted below may be the same or substantially the same as those of the first embodiment. The functions and configurations described in the second embodiment may be combined with the functions and configurations described in the first embodiment.

In the second embodiment, an example is described in which the information processing system 1 cooperates with an online conference system such as Zoom® or Teams® to generate a prompt based on text data of each speaker for a certain time span generated by a transcription function provided by the cooperating online conference system and to generate a corresponding image for each speaker. In the following description, such a cooperating online conference system may be referred to as (hereinafter, referred to as a “cooperative conference system.”

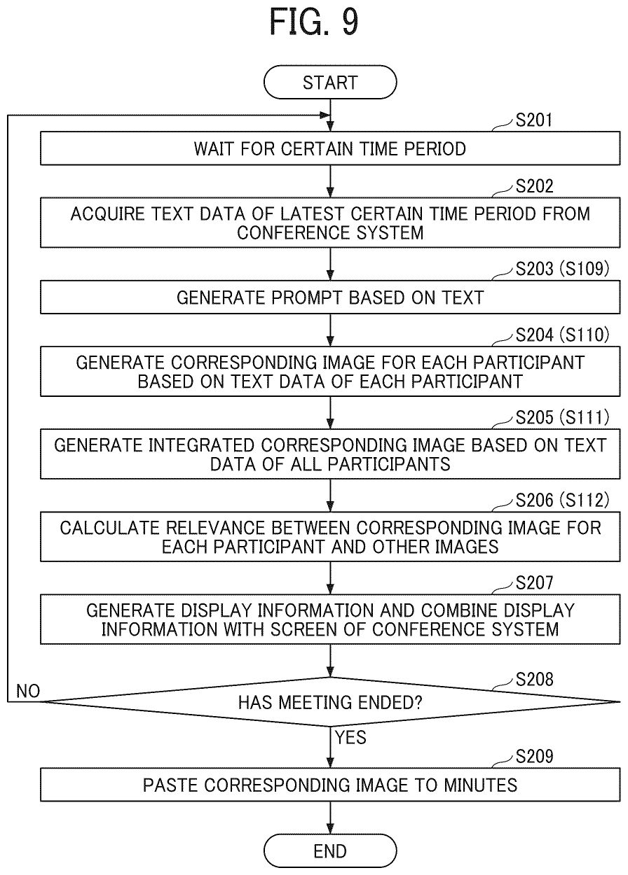

FIG. 9 is a flowchart of an example of an operation performed by the information processing system 1 according to the second embodiment. In FIG. 9, the same steps as the steps in FIG. 4 or steps corresponding to the steps in FIG. 4 are denoted by the step numbers of FIG. 4 enclosed in parentheses.

In step S201, the input data acquisition unit 41 waits until a certain time period (e.g., 20 seconds) has passed. On the terminal apparatus 10 of each of participants in the online meeting, a screen of the cooperative conference system is displayed.

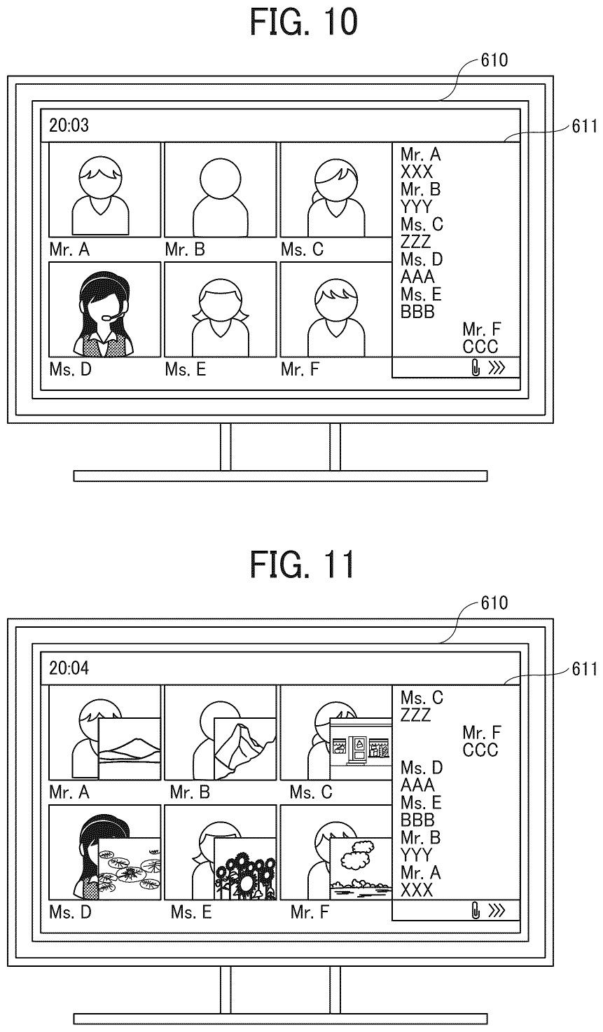

FIG. 10 is a diagram illustrating an example of a screen of the cooperative conference system. In FIG. 10, a screen 610 is an example of the screen of the cooperative conference system. The screen 610 includes a window for displaying respective videos of the participants and a text area 611. The text area 611 including the contents of the speeches by the participants in chronological order, which are converted into text by a transcription function.

In step S202, when the certain time period has elapsed, the input data acquisition unit 41 acquires, from the cooperative conference system, text data that is generated for each of the participants in the online meeting during the latest certain time period in association with the participant identification information of the participant who has spoken the content of the text data. The text data acquired in this step corresponds to a character string obtained by dividing the text data obtained from the start to the end of the online meeting in chronological order.

In subsequent steps S203 to S206, the same processes as those of steps S109 to S112 described with reference to FIG. 4 are performed for each of the acquired text data. As a result, an integrated corresponding image and corresponding images for the respective participants in the online meeting for the latest certain time period are generated. Either or both of the processes of steps S205 and S206 may be omitted. In other words, the integrated corresponding image does not have to be generated. The relevance degree does not have to be calculated.

In step S207, the display information generation unit 44 includes the corresponding images in the screen 610 of the cooperative conference system.

FIG. 11 is a diagram illustrating a first display example of a screen of the cooperative conference system including the corresponding images.

In the screen 610 illustrated in FIG. 11, a corresponding image of the participant corresponding to each window is superimposed on the window for each participant. Each window includes the participant identification information of each participant. Accordingly, in the screen 610, the corresponding image and the participant identification information are displayed in association with each other.

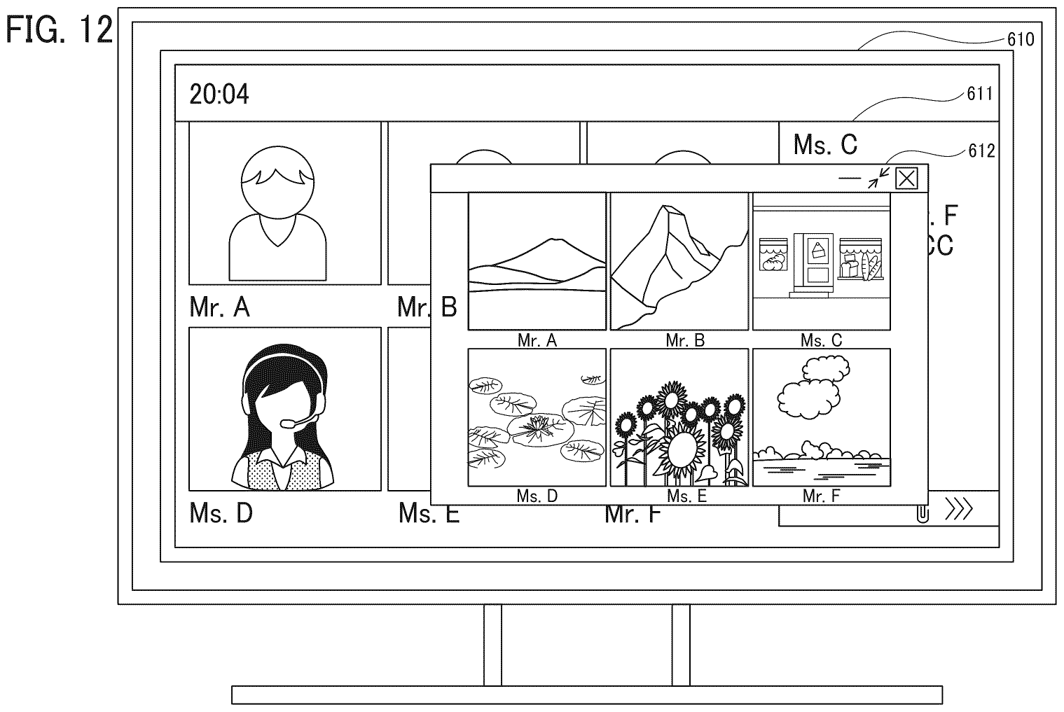

FIG. 12 is a diagram illustrating a second display example of a screen of the cooperative conference system including the corresponding images. In the screen 610 illustrated in FIG. 12, a pop-up screen 612 that includes the corresponding images of the participant in association with the participant identification information is superimposed and displayed.

When the integrated corresponding image is generated or when the relevance degree is generated, the integrated corresponding image or the relevance degree may also be displayed on the screens illustrated in FIG. 11 and FIG. 12. The relevance degree may be displayed in a manner that one can recognize the association between the corresponding image relating to the relevance degree and the relevance degree.

The processes of steps S201 to S207 are repeatedly performed until the online meeting ends. This enables the participants to have a discussion while checking the corresponding image of each participant at constant intervals as the meeting progresses. As a result, more lively discussion and the creation of new ideas are expectable.

When the online meeting ends (Yes in S208), in step S209, the display information generation unit 44 adds (pastes), in minutes data generated by the cooperative conference system, the thumbnails of the corresponding images generated at a certain timing to a position corresponding to the certain timing when the corresponding images generated repeatedly are generated. The minutes data includes text data indicating the content of speech of each participant in association with the participant identification information of the participant corresponding to the text data in chronological order). The text data indicating the content of speech of each participant text data is character strings obtained by dividing text data of the entire meeting in chronological order. The minutes data is an example of display information including a character string obtained by dividing text data obtained from the start to the end of the online meeting in chronological order. Instead of the minutes system, the display information generation unit 44 may generate the minutes data based on the text data acquired in step S202.

The minutes data is transmitted to the terminal apparatus 10 in response to a predetermined operation on the terminal apparatus 10, and the display control unit 13 of the terminal apparatus 10 controls the display of the minutes data.

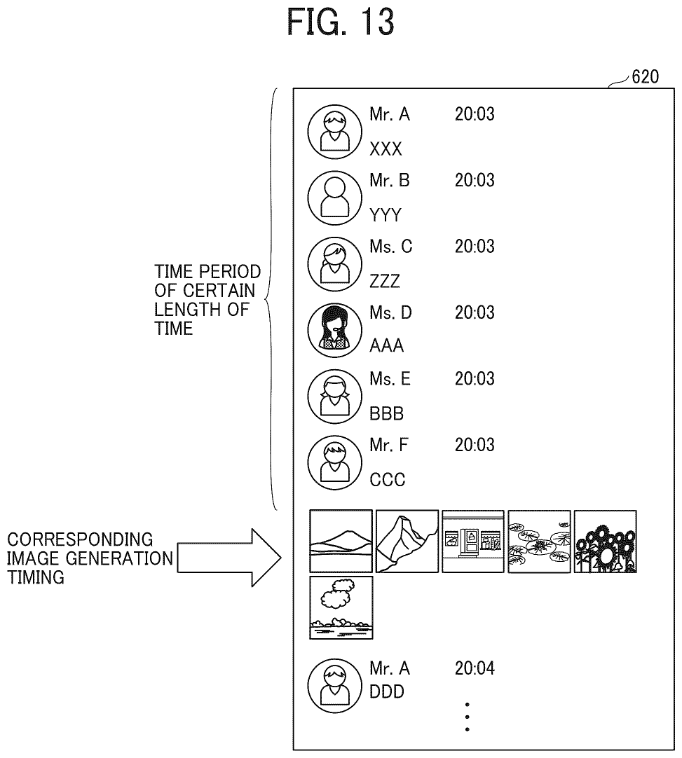

FIG. 13 is a diagram illustrating a display example of minutes data. As illustrated in FIG. 13, minutes data 620 includes, for each time period of a certain length of time, text data (character strings obtained by dividing the text data in chronological order) corresponding to the contents of speeches in the time period in chronological order. The minutes data 620 further includes the thumbnails of corresponding images based on text data corresponding to the contents of speeches of the participants during the time period at a position corresponding to the end of the time period (i.e., the timing of generating the corresponding images). The corresponding image may be enlarged or saved by clicking on the thumbnail image.

The minutes data 620 allows the user to visually review the meeting and serve as a memory trigger.

In the first embodiment, too, the corresponding image and the integrated corresponding image may be generated at constant intervals, and the corresponding image and the integrated image may be displayed. The user may set whether to generate the corresponding image and the integrated corresponding image. In other words, the part of the text data from the start to the end of the meeting that the image generation unit 42 uses to generate the corresponding image may be changeable based on the designation of the “start” point and the “end” point by the user or a particular condition set in the system.

In a case where the corresponding image or the like is generated at constant intervals, when the relevance degree or the common understanding level continues to be significantly low, a message prompting the user to review the agenda may be output.

A third embodiment is described below. In the third embodiment, elements, members, components, or operations that are different from those of the first embodiment are described. In other words, elements, members, components, or operations of which description are omitted below may be the same or substantially the same as those of the first embodiment. The functions and configurations described in the third embodiment may be combined with the functions and configurations described in the first embodiment.

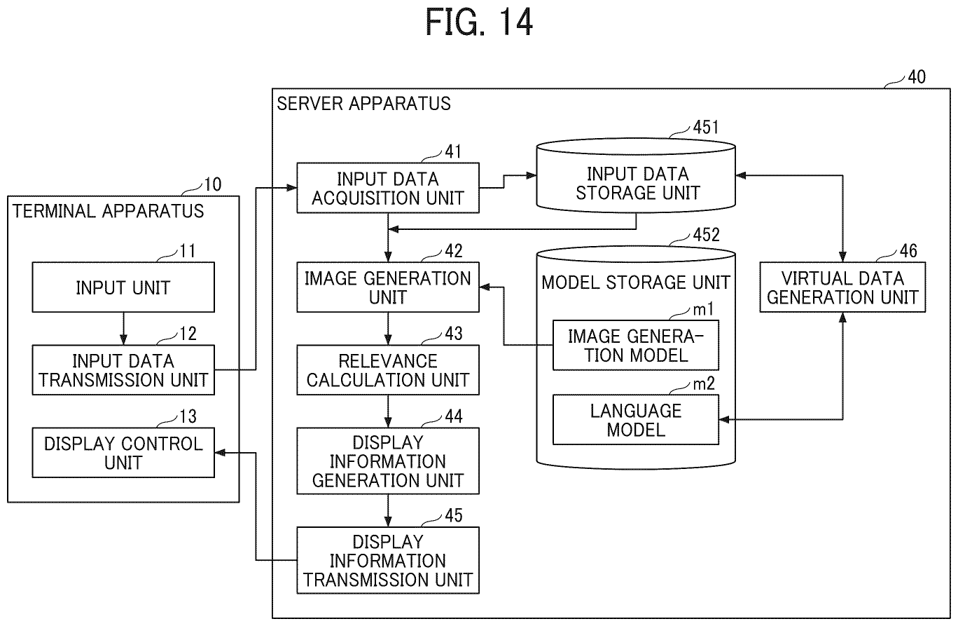

FIG. 14 is a diagram illustrating a functional configuration of the information processing system 1 according to the third embodiment. In FIG. 14, like reference signs are allocated to the same components as those of FIG. 3, and the descriptions thereof are omitted as appropriate.

In the functional configuration illustrated in FIG. 14, the server apparatus 40 further includes a virtual data generation unit 46. The model storage unit 452 further stores a language model m2. The virtual data generation unit 46 is implemented by processes executed by the CPU 401 according to one or more programs installed on the server apparatus 40.

The language model m2 is a machine learning model that receives text as input and outputs a sentence having a content corresponding to the text in a text format. For example, an existing large language model (LLM) can be used as the language model m2.

The virtual data generation unit 46 performs virtual (pseudo) speech in the target meeting as a virtual participant like a chatbot. The virtual data generation unit 46 generates unique data (e.g., text data indicating speech content) indicating virtual unique information (e.g., text indicating speech content) of the virtual participant based on the unique data (e.g., text data indicating speech content) of the other participants, for example, at a timing of constant intervals during the target meeting. In the following description, such a timing may be referred to as a “virtual speech timing.” In the following description, such a constant interval may be referred to as a “virtual speech interval.” The virtual data generation unit 46 uses the language model m2 when generating the unique data.

For example, each time the virtual speech timing arrives, the virtual data generation unit 46 generates text data by performing the same or substantially the same process as that of step S108 on each piece of voice data recorded in the input data storage unit 451 in step S107 that is performed during the immediately preceding virtual speech interval (the entire time period of that virtual speech interval or the last one to three minutes of that virtual speech interval). The virtual data generation unit 46 inputs, to the language model m2, a prompt including the text data and an instruction such as “Speak as a participant of the meeting based on the agenda and the contents of the speeches of other participants.” The virtual data generation unit 46 generates voice data in which text data generated by the language model m2 based on the prompt is used as a speech content, causes each of the terminal apparatuses 10 to output the voice data, and records the text data in the input data storage unit 451 in association with the identification information of the virtual participant. The voice data in which the text data is used as the speech content can be generated using a known voice synthesis technology.

In the third embodiment, in the processes of step S109 and the subsequent steps, the text data (i.e., the speech content) of the virtual participant is also treated in the same or substantially the same manner as the text data of the other participants. In other words, a corresponding prompt is generated for the text data of the virtual participant in step S109, and a corresponding image is generated based on the corresponding prompt. The subsequent processes may be the same or substantially the same as those in the first embodiment.

The virtual speech timing does not have to be at constant intervals. For example, a timing when the number of speeches in the target meeting is small (e.g., in a case where the number of speeches in a latest certain time period is equal to or smaller than a threshold value) may be set as the virtual speech timing.

As described above, according to the third embodiment, by adding the virtual participant, more lively discussion in the target meeting is expectable.

The fourth embodiment is described below. In the fourth embodiment, elements, members, components, or operations that are different from those of the first embodiment are described. In other words, elements, members, components, or operations of which description are omitted below may be the same or substantially the same as those of the first embodiment. The functions and configurations described in the fourth embodiment may be combined with the functions and configurations described in the first embodiment.

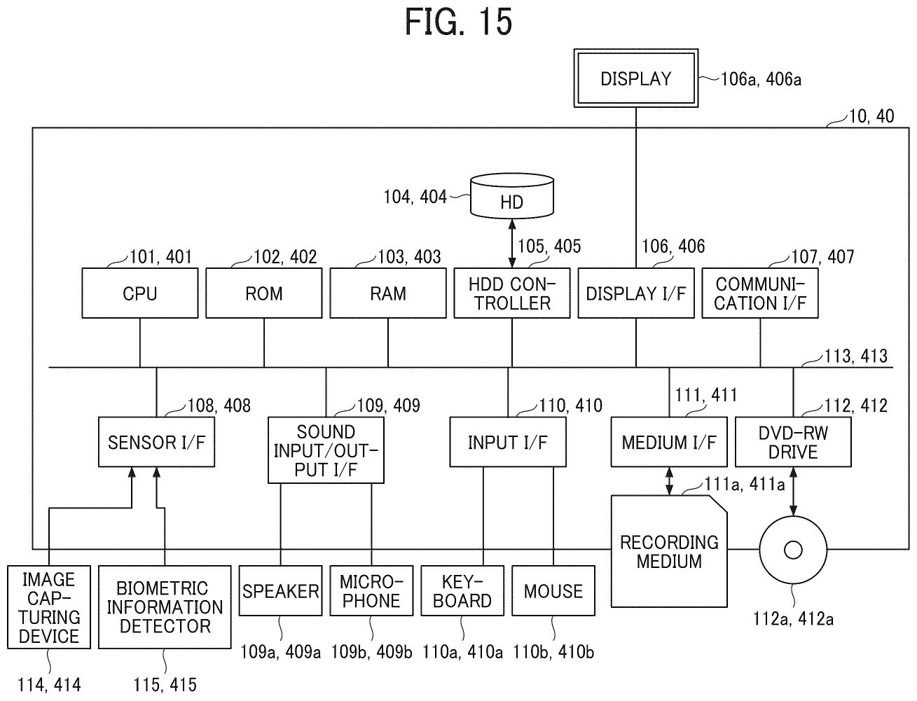

FIG. 15 is a block diagram illustrating a hardware configuration of the terminal apparatus 10 according to the fourth embodiment. In the hardware configuration illustrated in FIG. 15, an image capturing device 114 and a biometric information detector 115 are connected to the terminal apparatus 10.

The image capturing device 114 is a camera that captures an image including the face, posture, or the like of a user (a participant in the target meeting) of the terminal apparatus 10. The image captured by the image capturing device 114 may be a moving image or a still image captured at constant time intervals.

Examples of the biometric information detector 115 include a sensor that measures biometric information such as blood pressure or pulse of the user (participant in the target meeting) of the terminal apparatus 10.

In the fourth embodiment, the unique data includes a first type of unique data including a first type of unique information and a second type of unique data including a second type of unique information. The first type of unique information is text indicating at least one of characters input by the participant during the meeting and the content of speech made by the participant during the meeting. The second type of unique information is unique information based on a reaction by any of the other participants to the first type of unique information. The second type of unique information includes at least one of operation information (e.g., entered characters) indicating an operation input by a participant who reacts to the first type of unique information of any of the other participants, captured image information of the participant captured by the image capturing device 114, and biometric information of each of the participants detected by the biometric information detector 115. The captured image information can be changed between being displayed on the display and not being displayed on the display.

In other words, the image capturing device 114 and the biometric information detector 115 are used to detect a reaction to, for example, a speech by another participant.

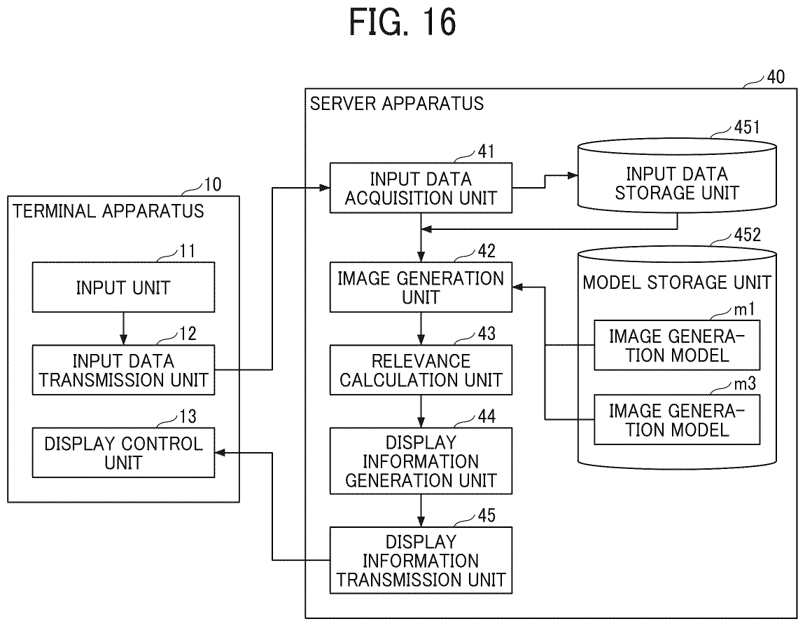

FIG. 16 is a diagram illustrating a functional configuration of the information processing system 1 according to the fourth embodiment. In FIG. 16, like reference signs are allocated to the same components as those of FIG. 3, and the descriptions thereof are omitted as appropriate.

In the functional configuration illustrated in FIG. 16, the model storage unit 452 further stores an image generation model m3. The image generation model m3 is a machine learning model that receives the first type of unique data of a first participant and the second type of unique data of a second participant as inputs and outputs a corresponding image corresponding to the first type of unique data and the second type of unique data (i.e., a corresponding image relating to a reaction to a speech by another participant). Accordingly, the corresponding image is an image relating to a reaction of the second participant who reacted to the speech by the first participant.

The image generation model m3 is pretrained by using training data. The training data includes, as input data, text (i.e., text indicating the speech content by another participant), operation information (i.e., operation information to the terminal apparatus 10) of a participant who have reacted to the other participant (may be referred to as a “participant R” in the following description), captured image information such as a face or posture of the participants R, and biometric information such as blood pressure or pulse of the participants R. In the following description, the operation information, captured image information, and the biometric information of the participant R may be referred to as “reaction information.” The training data includes an image as a correct answer. In the following description, the image as a correct answer may be referred to as a “correct image.” In other words, the image generation model m3 is trained such that an image output by the image generation model m3 to which the input data included in the training data is input becomes closer to an image as the correct answer in the training data. When the reaction information relating to the input data of the training data indicates a positive reaction to the speech by another participant, an image having a relatively high relevance degree with respect to the corresponding image generated by the image generation model m1 for the speech by the other participant is an image as a correct answer in the training data. By contrast, when the reaction information relating to the input data of the training data indicates a negative reaction to the speech by another participant, an image having a relatively low relevance degree with respect to the corresponding image generated by the image generation model m1 for the speech by the other participant is an image as a correct answer in the training data.

Accordingly, when the input reaction information (the reaction information of the participant R) is positive with respect to the speech by another participant, the image generation model m3 generates a corresponding image having a relatively high relevance degree with respect to the corresponding image of the text of the input speech content of the other participant. When the input reaction information (the reaction information of the participant R) is negative with respect to the speech by another participant, the image generation model m3 generates a corresponding image having a relatively low relevance degree with respect to the corresponding image of the text of the input speech content of the other participant.

An operation according to the fourth embodiment is described below with reference to FIG. 4. The input data transmission unit 12 of each of the terminal apparatuses 10 transmits reaction information of the user of the terminal apparatus 10 to the server apparatus 40 in response to the speeches of participants corresponding to the users of the other terminal apparatuses 10. The input data acquisition unit 41 of the server apparatus 40 records, for each participant, the received reaction information in the input data storage unit 451. Thus, during a time period until the target meeting ends, the reaction information of the other participants is stored in the input data storage unit 451 for each piece of voice data relating to the speech by each participant.

In step S110, the image generation unit 42 further inputs, for each participant, reaction information of the participant to the other participants and text data of the speeches by the other participants to the image generation model m3, and acquires an image output by the image generation model m3 as a corresponding image relating to the reaction of the participant.

For example, when Mr. B smiles (i.e., has a positive reaction) to speech by Mr. A, it means that Mr. B agrees with the speech by Mr. A (i.e., is positive about the speech by Mr. A). Thus, a corresponding image that has a high relevance degree (is highly related) with respect to the corresponding image relating to the speech by Mr. A is generated for Mr. B.

By contrast, when Mr. B shows a dissatisfied expression (i.e., has a negative reaction) to speech by Mr. A, it means that Mr. B disagrees with the speech by Mr. A (i.e., is negative about the speech by Mr. A). Thus, a corresponding image for Mr. B that has a low relevance degree with respect to the corresponding image relating to the speech by Mr. A is generated for Mr. B.

The above description is of an example in which the facial expression is used as the reaction information. Alternatively or in addition, by labeling positive and negative reactions to the participant's posture, pulse rate, etc. and having the image generation model m3 learn these, a corresponding image can be generated in the same or substantially the same manner as the facial expression.

The other processes may be the same or substantially the same as those in the first embodiment.

As a result, according to the fourth embodiment, the corresponding image relating to the reaction to the speech by another participant is also displayed.

The fourth embodiment may be combined with any one or more of the above-described embodiments.

As described above, according to the fourth embodiment, the reaction of one participant to speech by another participant can also be expressed by an image.

A fifth embodiment is described below. In the fifth embodiment, elements, members, components, or operations that are different from those of the third embodiment are described. In other words, elements, members, components, or operations of which description are omitted below may be the same or substantially the same as those of the third embodiment. The functions and configurations described in the fifth embodiment may be combined with the functions and configurations described in the third embodiment.

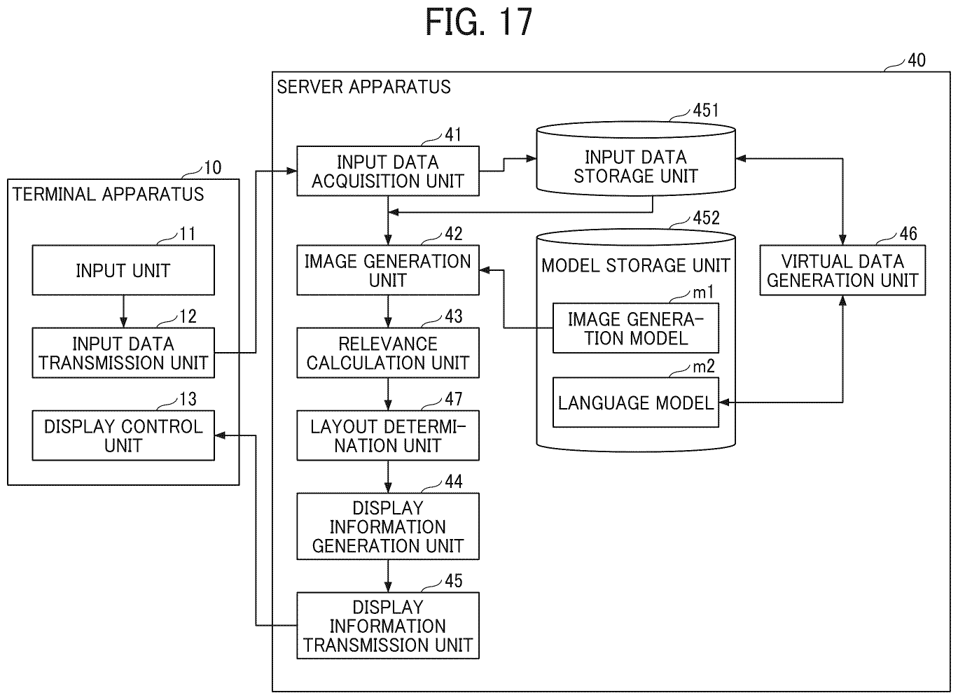

FIG. 17 is a diagram illustrating a functional configuration of the information processing system 1 according to the fifth embodiment. In FIG. 17, like reference signs are allocated to the same components as those of FIG. 14, and the descriptions thereof are omitted as appropriate.

In the functional configuration illustrated in FIG. 17, the server apparatus 40 further includes a layout determination unit 47. The layout determination unit 47 is implemented by processes executed by the CPU 401 according to one or more programs installed on the server apparatus 40.

The layout determination unit 47 determines at least one of the arrangement of multiple corresponding images, the size of each of the corresponding images, and the decoration when the corresponding images are displayed, based on at least one of the unique information (text indicating a speech content or the voice of the speech) and the corresponding images.

Specifically, the layout determination unit 47 determines the arrangement of corresponding images to be displayed based on the relevance degree that is calculated by the relevance calculation unit 43 for each corresponding image with respect to another image.

The layout determination unit 47 determines the decoration or size of the corresponding image based on at least one of the amount of speech by the participant, the voice volume, the image information indicating the facial expression of the other participant captured by the image capturing device 114, and the change in the biometric information of the other participant detected by the biometric information detector 115, which are included in the unique information. In this case, it suffices that the terminal apparatus 10 have the hardware configuration as illustrated in FIG. 15 and that as described in the fourth embodiment, the reaction information is recorded in the input data storage unit 451.

In the fifth embodiment, the display information generation unit 44 generates display information for displaying the corresponding images in at least one of the arrangement, size, and decoration determined by the layout determination unit 47.

Specially, before the display information generation unit 44 generates the display information in step S113 of FIG. 4, the layout determination unit 47 determines the arrangement positions (arrangement order) of the corresponding images based on the relevance degree (relevance degree with respect to another image) calculated in step S112 for each corresponding image of each participant (including the virtual participant). For example, the layout determination unit 47 determines the arrangement positions of the corresponding images so that a corresponding image having a relatively high relevance degree with a certain image is relatively close to the certain image. The certain image may be any one of the corresponding images, may be the integrated corresponding image, or may be an agenda image. The agenda image is an image generated by inputting text data indicating an agenda to the image generation model m1.

Further, for each of the corresponding images, the layout determination unit 47 increases the size of the corresponding image or adds a decoration, such as highlight display, that makes the corresponding image stand out, as the amount of speech of the participant relating to the corresponding image increases or the volume of the speech increases. Furthermore, the layout determination unit 47 increases the size of the corresponding image or adds decoration, such as highlight display, that makes the corresponding image stand out, as the reaction indicated by the reaction information with respect to the speech relating to the corresponding image is greater (i.e., as the influence on the other participants is greater) for each corresponding image.

The amount of speech of the participant relating to the certain corresponding image can be evaluated based on the number of characters of text data corresponding to the corresponding image (or the participant) or the length of voice data corresponding to the text data. The volume of the speech of the participant relating to the certain corresponding image can be evaluated based on the voice data corresponding to the corresponding image (or the participant). For example, the average value or the maximum value of the volume of the voice data may be set as the volume of the speech relating to the voice data. The magnitude of the reaction indicated by the reaction information can be evaluated using a known technology, for example, a technology disclosed in https://aicam.jp/tech/optical_flow.

The layout determination unit 47 may perform structuring on a conversation based on the flow of the conversation (i.e., by using the order of speeches and natural language processing) based on text data (speech content) corresponding to each corresponding image, and determine the arrangement of the corresponding images based on the structure. The structuring refers, for example, the following (1) and (2).

(1) A structure obtained by the structuring is a chronological structure of the conversation, that is, the order of speeches. In this case, the layout determination unit 47 determines the layout according to the time-series flow of the speeches corresponding to the corresponding images.

(2) The structuring refers to converting the conversation into a network-like structure using a graph obtained by natural language processing such as a knowledge graph or a co-occurrence network. In the graph, each speech is a node, and related speeches are connected by edges. In this case, the layout determination unit 47 determines the layout of the corresponding images based on the relevance degree between the speeches.

In step S113, the display information generation unit 44 generates display information (e.g., a screen) for displaying the generated image (e.g., the corresponding images or the integrated corresponding image, or the corresponding images and the integrated corresponding image) based on the display form determined by the layout determination unit 47.

As a result, in the fifth embodiment, the corresponding images and the like are displayed on each of the terminal apparatuses 10 in the display form determined by the layout determination unit 47.

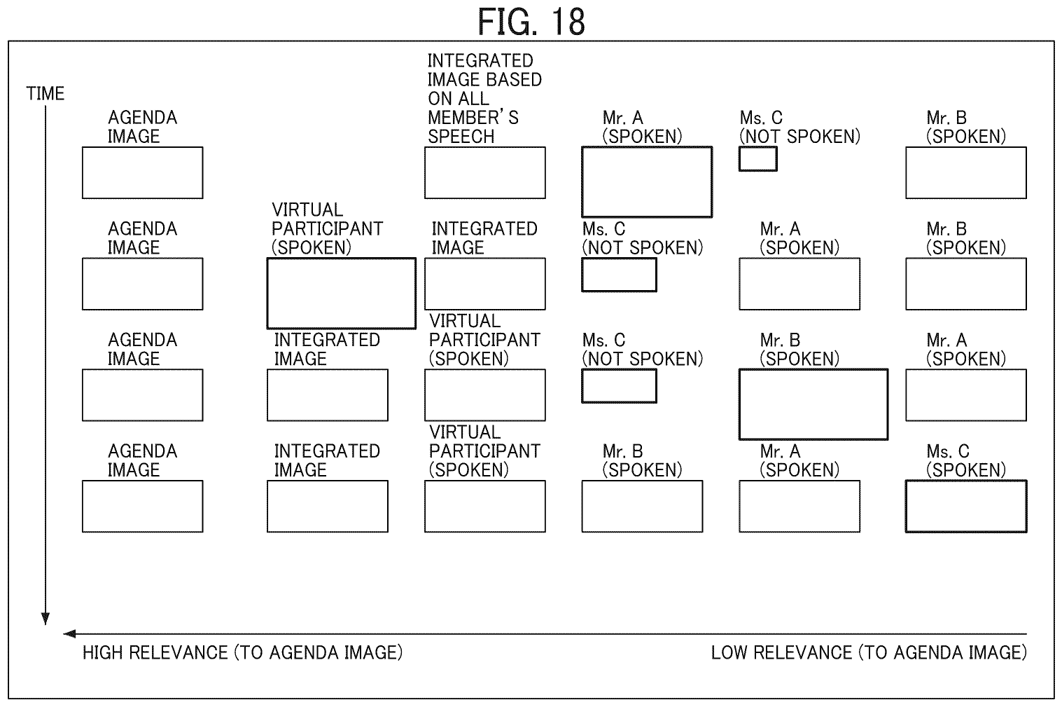

FIG. 18 is a diagram illustrating a display example of the corresponding images and the like according to the fifth embodiment. In FIG. 18, the vertical direction corresponds to the time axis (i.e., the passage of time). The horizontal direction corresponds to the relevance degree with respect to the agenda image.

In this case, the arrangement of the corresponding images is determined in chronological order and based on the degree of the relevance to the agenda image. The size and the decoration of each corresponding image are determined by the above-described method.

In the first embodiment, the description is given of an example in which the processes of step S108 and subsequent steps are executed in response to the end of the meeting. Alternatively, the processes of step S108 and subsequent steps may be repeated at constant intervals during the meeting. FIG. 18 illustrates an example in which the corresponding images and the like generated at constant intervals are arranged on the time axis in such a case. Although FIG. 18 illustrates an example in which the agenda images are arranged at constant intervals, the agendas corresponding to the agenda images may be the same or different. In other words, the agenda may be changed during the meeting.

The fifth embodiment may be combined with any one or more of the above-described embodiments. In FIG. 18, a corresponding image to which a character string “(not spoken)” is attached indicates that the corresponding image is generated based on the reaction information as described in the fourth embodiment.

As described above, according to the fifth embodiment, the display form of each corresponding image can be changed according to the influence of the corresponding image on the meeting. As a result, the magnitude of the influence of the corresponding images is visually expressed.

The functionality of the elements disclosed herein may be implemented using circuitry or processing circuitry which includes general purpose processors, special purpose processors, integrated circuits, application-specific integrated circuits (ASICs), digital signal processors (DSPs), field-programmable gate arrays (FPGAs), and/or combinations thereof which are configured or programmed, using one or more programs stored in one or more memories, to perform the disclosed functionality. Processors are considered processing circuitry or circuitry as they include transistors and other circuitry therein. In the disclosure, the circuitry, units, or means are hardware that carry out or are programmed to perform the recited functionality. The hardware may be any hardware disclosed herein which is programmed or configured to carry out the recited functionality.

There is a memory that stores a computer program which includes computer instructions. These computer instructions provide the logic and routines that enable the hardware (e.g., processing circuitry or circuitry) to perform the method disclosed herein. This computer program can be implemented in known formats as a computer-readable storage medium, a computer program product, a memory device, a record medium such as a CD-ROM or DVD, and/or the memory of an FPGA or ASIC.

The apparatuses or devices described in the embodiments described above are merely one example of multiple computing environments that implement one or more embodiments of the disclosure.

In some embodiments, the server apparatus 40 includes multiple computing devices, such as server clusters. The multiple computing devices communicate with one another through any type of communication link including a network and a shared memory, and perform the processes disclosed in the present disclosure.

In the embodiments, the terminal apparatus 10 and the server apparatus 40 are examples of an information processing apparatus.

The system according to the related art only searches for an illustration or an image corresponding to language information recognized from speech or text and outputs the illustration or image.

According to one or more embodiments of the present disclosure, visualization is performed according to unique information of each participant in a meeting.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention. Any one of the above-described operations may be performed in various other ways, for example, in an order different from the one described above.

Aspects of the present disclosure are, for example, as follows.

### Aspect 1

According to Aspect 1, an information processing apparatus includes an acquisition unit to acquire unique data indicating unique information of each of a plurality of participants who participate in a gathering on the basis of an activity of each of the plurality of participants during the gathering. The information processing apparatus includes an image generation unit to generate, respectively for the plurality of participants, corresponding images corresponding to the unique data acquired by the acquisition unit, on the basis of the unique data acquired by the acquisition unit and a machine learning model trained using training data including the unique data indicating the unique information and an image.

### Aspect 2

According to Aspect 2, the information processing apparatus of Aspect 1 further includes a virtual data generation unit to generate virtual unique data of a virtual participant on the basis of the unique data of the plurality of participants. The image generation unit generates, for the virtual participant, a corresponding image corresponding to the virtual unique data on the basis of the virtual unique data and the machine learning model.

### Aspect 3

According to Aspect 3, in the information processing apparatus of Aspect 1 or 2, the unique data includes a first type of unique data including a first type of unique information and a second type of unique data including a second type of unique information based on a reaction to any of the first type unique information. The image generation unit generates, on the basis of the first type of unique data of a first participant, the second type of unique data of a second participant, and a machine learning model, a corresponding image for the second participant, which corresponds to the first type of unique data and the second type of unique data.

### Aspect 4

According to Aspect 4, in the information processing apparatus of Aspect 3, the first type of unique information is text indicating at least one of characters input by each of the plurality of participants or a content of speech of each of the plurality of participants. The second type of unique information includes at least one of operation information indicating an operation input by each of the plurality of participants, captured image information of each of the plurality of participants captured by an image capturing device, and biometric information of each of the plurality of participants detected by a biometric information detector.

### Aspect 5

According to Aspect 5, in the information processing apparatus of any one of Aspects 1 to 4, the image generation unit further generates an integrated corresponding image corresponding to a set of the unique data acquired by the acquisition unit for the plurality of participants on the basis of the set of the unique data and the machine learning model.

### Aspect 6

According to Aspect 6, in the information processing apparatus of any one of Aspects 1 to 5, the machine learning model is trained using training data including text and an image. The image generation unit generates, respectively for the plurality of participant, corresponding images corresponding to a plurality pieces of text data each indicating a content of speech of each of the participants in the gathering, on the basis of the plurality of pieces of text data and the machine learning model.

### Aspect 7

According to Aspect 7, in the information processing apparatus of Aspect 6, the image generation unit generates the corresponding images on the basis of the plurality of pieces of text data, image data input in association with the gathering, and the machine learning model.

### Aspect 8

According to Aspect 8, the information processing apparatus of any one of Aspects 1 to 7 further includes a display information generation unit to generate display information for displaying a plurality of pieces of participant identification information respectively identifying the plurality of participants in association with the corresponding images generated for the plurality of participants.

### Aspect 9

According to Aspect 9, the information processing apparatus of Aspect 8 further includes a relevance calculation unit to calculate relevance degrees between respective ones of the corresponding images and another image. The display information generation unit generates the display information for displaying the relevance degrees in association with the plurality of pieces of participant identification information and the corresponding images.

### Aspect 10

According to Aspect 10, in the information processing apparatus of Aspect 9, the relevance calculation unit generates a relevance degree between the corresponding images.

### Aspect 11

According to Aspect 11, the information processing apparatus of Aspect 5 further includes a relevance calculation unit to generate relevance degrees indicating relevance degrees between the corresponding images and the integrated corresponding image. The information processing apparatus further includes a display information generation unit to generate display information for displaying a plurality of pieces of participant identification information respectively identifying the plurality of participants, the corresponding images generated for the plurality of participants, and the relevance degrees generated for the corresponding images in association with each other.

### Aspect 12

According to Aspect 12, the information processing apparatus of any one of Aspects 1 to 7 further includes a layout determination unit to determine at least one of an arrangement of the corresponding images, a size of each of the corresponding images, or a decoration when the corresponding image is displayed on the basis of at least one of the unique information or the corresponding images. The information processing apparatus further includes a display information generation unit to generate display information for displaying the corresponding images in at least one of the arrangement, the size, or the decoration determined by the layout determination unit.

### Aspect 13

According to Aspect 13, the information processing apparatus of Aspect 12 further includes a relevance calculation unit to calculate relevance degrees between respective ones of the corresponding images and another image. The layout determination unit determines the arrangement on the basis on the relevance degrees.

### Aspect 14

According to Aspect 14, in the information processing apparatus of Aspect 12 or 13, the layout determination unit determines the decoration or the size of each of the corresponding images on the basis of at least one of an amount of speech by each of the plurality of participants, a voice volume, image information indicating a facial expression of another participant captured by an image capturing device, and a change in biometric information of the another participant detected by the biometric information detector, which are included in the unique information.

### Aspect 15

According to Aspect 15, in the information processing apparatus of Aspect 8, the display information generation unit generates the display information for displaying the plurality of pieces of participant identification information, the corresponding images generated for the plurality of participants, and the unique data corresponding to the plurality of participants in association with each other.

### Aspect 16

According to Aspect 16, in the information processing apparatus of Aspect 15, the image generation unit generates, on the basis of the machine learning model and character strings obtained by dividing the text data included in the unique data acquired by the acquisition unit in chronological order, the corresponding images corresponding to the character strings respectively for the plurality of participants. The display information generation unit generates the display information for displaying the character strings in chronological order.

### Aspect 17

According to Aspect 17, in the information processing apparatus of any one of Aspects 1 to 16, a part of the unique data used by the image generation unit to generate the corresponding images is changeable.

### Aspect 18

According to Aspect 18, an information processing system includes an acquisition unit to acquire unique data indicating unique information of each of a plurality of participants who participate in a gathering on the basis of an activity of each of the plurality of participants during the gathering. The information processing system includes an image generation unit to generate, respectively for the plurality of participants, corresponding images corresponding to the unique data acquired by the acquisition unit, on the basis of the unique data acquired by the acquisition unit and a machine learning model trained using training data including the unique data indicating the unique information and an image.

### Aspect 19

According to Aspect 19, an information processing method performed by a computer includes acquiring unique data indicating unique information of each of a plurality of participants who participate in a gathering on the basis of an activity of each of the plurality of participants during the gathering. The information processing method includes generating, respectively for the plurality of participants, corresponding images corresponding to the acquired unique data, on the basis of the acquired unique data and a machine learning model trained using training data including the unique data indicating the unique information and an image.

### Aspect 20

According to Aspect 20, a program causes a computer to perform a method. The method includes acquiring unique data indicating unique information of each of a plurality of participants who participate in a gathering on the basis of an activity of each of the plurality of participants during the gathering. The method includes generating, respectively for the plurality of participants, corresponding images corresponding to the acquired unique data, on the basis of the acquired unique data and a machine learning model trained using training data including the unique data indicating the unique information and an image.

1. An information processing apparatus comprising circuitry configured to:
acquire, for each of a plurality of participants who participate in a gathering, unique data indicating unique information of the participant based on an activity of the participant during the gathering; and
generate, for each of the plurality of participants, a corresponding image corresponding to the acquired unique data, based on the acquired unique data and a machine learning model trained using training data including the unique data indicating the unique information and an image.

2. The information processing apparatus according to claim 1, wherein the circuitry is further configured to:
generate virtual unique data of a virtual participant based on the unique data of each of the plurality of participants; and
generate, for the virtual participant, a corresponding image corresponding to the virtual unique data, based on the virtual unique data and the machine learning model.

3. The information processing apparatus according to claim 1, wherein
the unique data includes a first type of unique data including a first type of unique information and a second type of unique data including a second type of unique information that is based on a reaction to the first type of unique information, and
the circuitry generates, based on a set of the first type of unique data of a first participant and the second type of unique data of a second participant and the machine learning model, the corresponding image for the second participant, the corresponding image corresponding to the set of the first type of unique data and the second type of unique data.

4. The information processing apparatus according to claim 3, wherein
the first type of unique information is text indicating at least one of characters input by the participant or a content of speech of the participant, and
the second type of unique information includes at least one of operation information indicating an operation input by the participant, captured image information of the participant captured by an image capturing device, or biometric information of the participant detected by a biometric information detector.

5. The information processing apparatus according to claim 1, wherein the circuitry further generates an integrated corresponding image corresponding to a set of unique data corresponding to the plurality of participants, based on the set of unique data and the machine learning model.

6. The information processing apparatus according to claim 1, wherein
the unique data includes text,
the machine learning model is trained using the training data including the text and the image, and
the circuitry generates, for each of the plurality of participants, the corresponding image corresponding to the text data indicating a content of speech of the participant in the gathering, based on the text data and the machine learning model.

7. The information processing apparatus according to claim 6, wherein the circuitry generates the corresponding image based on image data input in association with the gathering, in addition to the text data and the machine learning model.

8. The information processing apparatus according to claim 1, wherein the circuitry is further configured to generate display information for displaying, for each of the plurality of participants, participant identification information identifying the participant and the corresponding image of the participant in association with each other.

9. The information processing apparatus according to claim 8, wherein the circuitry is further configured to:
calculate a relevance degree between the corresponding image and another image; and
generate the display information for displaying the relevance degree in association with the corresponding image and the participant identification information.

10. The information processing apparatus according to claim 9, wherein the circuitry generates the relevance degree between the plurality of corresponding images.

11. The information processing apparatus according to claim 5, wherein the circuitry is further configured to:
generate, for each of the plurality of participants, a relevance degree indicating relevance between the corresponding image of the participant and the integrated corresponding image; and
generate display information for displaying participant identification information identifying the participant, the corresponding image of the participant, and the relevance degree of the correspondence image in association with each other.

12. The information processing apparatus according to claim 1, wherein,
the circuitry is further configured to:
determine at least one of an arrangement, sizes, or a decoration of the plurality of corresponding images to be displayed, based on at least one of unique information corresponding to the plurality of participants or the plurality of corresponding images; and
generate display information for displaying the plurality of corresponding images in at least one of the determined arrangement, the determined sizes, or the determined decoration.

13. The information processing apparatus according to claim 12, wherein the circuitry is further configured to:
calculate relevance degrees between respective ones of the plurality of corresponding images and another image; and
determine the arrangement based on the relevance degrees.

14. The information processing apparatus according to claim 12, wherein the circuitry determines the decoration or the size of each of the plurality of corresponding images, based on at least one of an amount of speech by each of the plurality of participants, a voice volume of the speech, image information indicating a facial expression of another participant of the plurality of participants captured by an image capturing device, or a change in biometric information of said another participant detected by a biometric information detector, the amount of speech by each of the plurality of participants, the voice volume of the speech, the image information indicating the facial expression of said another participant captured by the image capturing device, and the change in the biometric information of said another participant detected by the biometric information detector being included in the unique information.

15. The information processing apparatus according to claim 8, wherein the circuitry generates the display information for displaying the participant identification information identifying each of the plurality of participants, the plurality of corresponding images generated for the plurality of participants, and the unique data of the plurality of participants in association with each other.

16. The information processing apparatus according to claim 15, wherein the circuitry:
generates, based on the machine learning model and character strings obtained by dividing text data included in the acquired unique data in chronological order, the corresponding image corresponding to the character strings for each of the plurality of participants; and
generates the display information for displaying the character strings in chronological order.

17. The information processing apparatus according to claim 1, wherein a part of the unique data used to generate the corresponding image is changeable.

18. An information processing system comprising circuitry configured to:
acquire, for each of a plurality of participants who participate in a gathering, unique data indicating unique information of the participant based on an activity of the participant during the gathering; and
generate, for each of the plurality of participants, a corresponding image corresponding to the acquired unique data, based on the acquired unique data and a machine learning model trained using training data including the unique data indicating the unique information and an image.

19. An information processing method performed by a computer, the information processing method comprising:
acquiring, for each of a plurality of participants who participate in a gathering, unique data indicating unique information of the participant based on an activity of the participant during the gathering; and
generating, for each of the plurality of participants, a corresponding image corresponding to the acquired unique data, based on the acquired unique data and a machine learning model trained using training data including the unique data indicating the unique information and an image.

20. A non-transitory recording medium storing a plurality of program codes which, when executed by one or more processors, causes the one or more processors to perform a method comprising:
acquiring, for each of a plurality of participants who participate in a gathering, unique data indicating unique information of the participant based on an activity of the participant during the gathering; and
generating, for each of the plurality of participants, a corresponding image corresponding to the acquired unique data, based on the acquired unique data and a machine learning model trained using training data including the unique data indicating the unique information and an image.
